(19) United States
(12) Patent Application Publication
(10) Pub. No.: US 2016/0217613 A1
(43) Pub. Date: Jul. 28, 2016

(54) EXTENDABLE EYECUPS FOR A VIRTUAL REALITY HEADSET

(71) Applicant: Oculus VR, LLC, Menlo Park, CA (US)

(72) Inventor: Kam Cheong Chin, Irvine, CA (US)

(21) Appl. No.: 14/607,258

(22) Filed: Jan. 28, 2015

(51) Int. Cl. G06T 19/00; G02B 27/01

(52) U.S. Cl. CPC G06T 19/006; G02B 27/0172; G02B 2027/0178

(57) ABSTRACT

A virtual reality (VR) headset includes an optics block and an electronic display element outputting image light. The optics block includes a lens and an additional lens each configured to direct portions of the image light to corresponding exit pupils. A cone coupled to the lens and an additional cone coupled to the additional lens, the cone and additional cone configured to direct the image light toward the lens and additional lens, respectively. An extension ring is configured to couple to a mounting surface of a rigid body of the VR headset and to a base portion of the cone, and an additional extension ring is configured to couple to the mounting surface and to an additional base potion of the additional cone. Coupling one or more extension rings to the cone or to the additional cone allows modification of a distance between the lens or the additional lens and eyes of a user.

### BACKGROUND

The present disclosure generally relates to virtual reality headsets, and specifically relates to extendible eyecup assemblies in a virtual reality headset.

A virtual reality (VR) headset includes eyecup assemblies which pass light from an electronic display to the eyes of a user of the VR headset. The distance from a portion of an eyecup assembly of the VR headset to a user's eye generally affects the comfort of the user when using the VR headset and may affect the user's field of view of content displayed by the VR headset. A conventional VR headset includes multiple eyecup assemblies having different sizes, and a user chooses and installs a size of eyecup assembly in the VR headset that results in comfortable wear of the VR headset by the user and a desired field of view of the user. For example, a user wearing eyeglasses would likely select an eyecup assembly with a greater distance between a portion of the eyecup assembly and the user's eye than a different user who does not wear eyeglasses to comfortably accommodate the user's eyeglasses when using the VR headset. However, producing various sets of eyecup assemblies for use in a VR headset increases production costs of a VR headset.

### SUMMARY

A virtual reality (VR) headset includes an electronic display element and an optics block that includes two eyecup assemblies. Each eyecup assembly includes a lens and a cone coupled to the lens. The cone included in an eyecup assembly is capable of being coupled to a mounting surface of a rigid body of the VR headset or to an extension ring. One or more extension rings may be added to each eyecup assembly to decrease the spacing between an outer surface of the lens and a corresponding exit pupil of the VR headset, where an eye of a user of the VR headset would position the user's eye. Including extension rings in an eyecup assembly allows the user to adjust the spacing between the outer surface of a lens of the eyecup assembly and the user's eye, resulting in more comfortable use of the VR headset by the user. For example, a user who does not wear glasses couples two or more extension rings to each eyecup of the VR headset to reduce a distance between the user's eyes and lenses in each of the eyecups, which increases the user's field of view of the image displayed by the electronic display element in the VR headset. In another example, a user who wears eyeglasses would couple a single extension ring to each eyecup of the VR headset so a distance between the outer surfaces of each lens of the eyecup assemblies and the user's eyes is sufficiently large to accommodate for the user's eyeglasses.

Each eyecup assembly includes a cone having a base portion and a top portion. The cone is configured to receive the image light through the base portion and direct the image light toward a lens coupled to the top portion of the cone. An extension ring is configured to couple to a mounting surface of a rigid body of the VR headset and to the base portion of the cone. Hence, a distance between the mounting surface of the rigid body of the VR headset and the base portion of the cone is at least a thickness of the extension ring. Accordingly, removing the extension ring increases the spacing between the user's eye and an outer surface of the lens by the thickness of the extension ring. Likewise, adding an extension ring decreases the spacing between the user's eye and the outer surface of the lens by the thickness of the added extension ring.

### BRIEF DESCRIPTION OF THE DRAWINGS

FIG. 1 is a block diagram of a system environment including a virtual reality system, in accordance with an embodiment.

FIG. 2A is a wire diagram of a virtual reality headset, in accordance with an embodiment.

FIG. 2B is a cross section of a front rigid body of the VR headset in FIG. 2A, in accordance with an embodiment.

FIG. 3 is a wire diagram of an embodiment of the front rigid body of the VR headset shown in FIG. 2A having an eyecup assembly for the left eye mounted, in accordance with an embodiment.

FIG. 4A is a cross section of an eyecup assembly configured for use by a user with eyeglasses, in accordance with an embodiment.

FIG. 4B is a cross section of the eyecup assembly of FIG. 4A configured for use by a user without eyeglasses, in accordance with an embodiment.

FIG. 5 is a wire diagram of an exploded view of the eyecup assembly shown in FIG. 4B, in accordance with an embodiment.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Overview

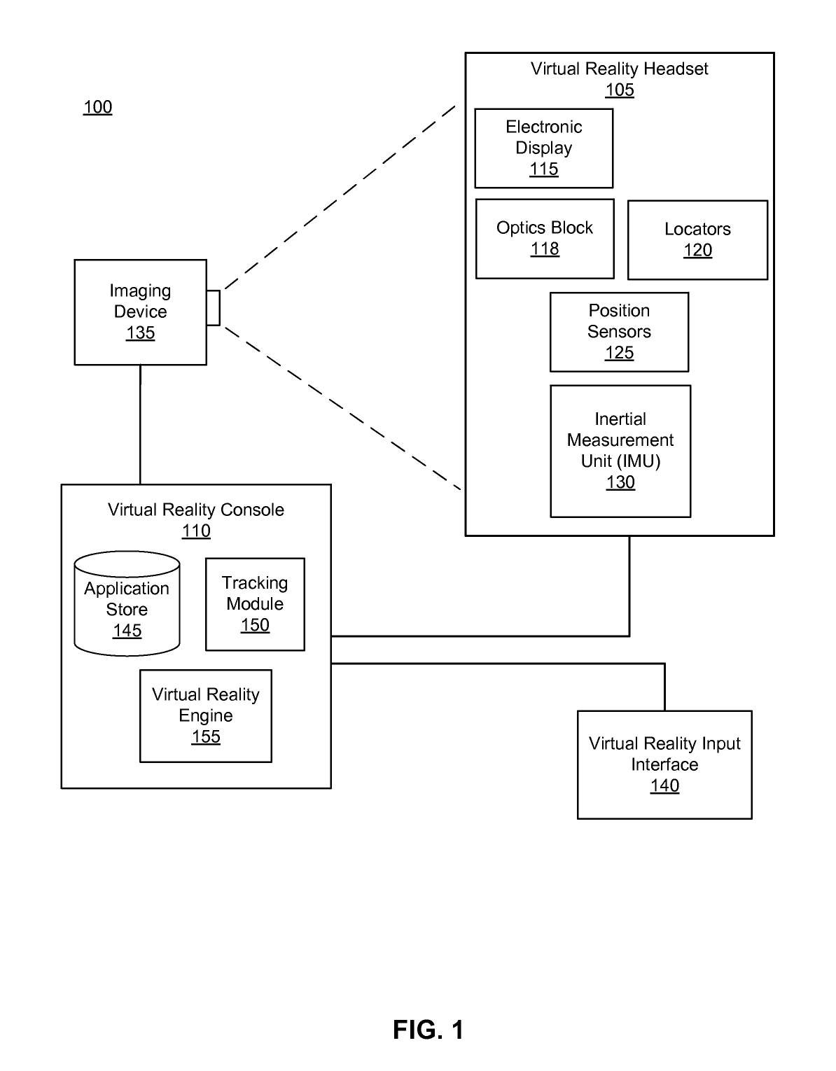

FIG. 1 is a block diagram of a virtual reality (VR) system environment 100 in which a VR console 110 operates. The system environment 100 shown by FIG. 1 comprises a VR headset 105, an imaging device 135, and a VR input interface 140 that are each coupled to the VR console 110. While FIG. 1 shows an example system environment 100 including one VR headset 105, one imaging device 135, and one VR input interface 140, in other embodiments any number of these components may be included in the system environment 100. For example, there may be multiple VR headsets 105 each having an associated VR input interface 140 and being monitored by one or more imaging devices 135, with each VR headset 105, VR input interface 140, and imaging devices 135 communicating with the VR console 110. In alternative configurations, different and/or additional components may be included in the system environment 100.

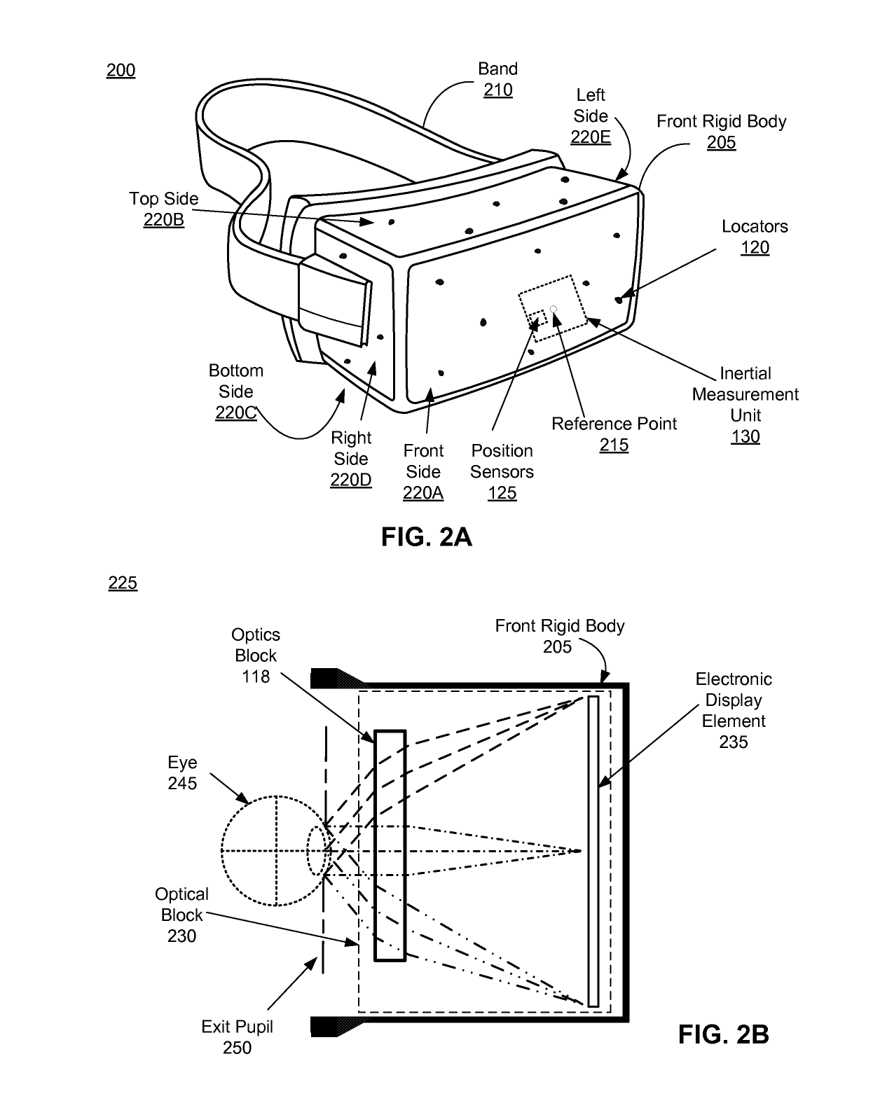

The VR headset 105 is a head-mounted display that presents media to a user. Examples of media presented by the VR head set include one or more images, video, audio, or some combination thereof. In some embodiments, audio is presented via an external device (e.g., speakers and/or headphones) that receives audio information from the VR headset 105, the VR console 110, or both, and presents audio data based on the audio information. An embodiment of the VR headset 105 is further described below in conjunction with FIGS. 2A and 2B. The VR headset 105 may comprise one or more rigid bodies, which may be rigidly or non-rigidly coupled to each other together. A rigid coupling between rigid bodies causes the coupled rigid bodies to act as a single rigid entity. In contrast, a non-rigid coupling between rigid bodies allows the rigid bodies to move relative to each other.

The VR headset 105 includes an electronic display 115, an optics block 118, one or more locators 120, one or more position sensors 125, and an inertial measurement unit (IMU) 130. The electronic display 115 displays images to the user in accordance with data received from the VR console 110. In various embodiments, the electronic display 115 may comprise a single electronic display or multiple electronic displays (e.g., a display for each eye of a user). Examples of the electronic display 115 include: a liquid crystal display (LCD), an organic light emitting diode (OLED) display, an active-matrix organic light-emitting diode display (AMOLED), some other display, or some combination thereof.

The optics block 118 magnifies received light, corrects optical errors associated with the image light, and presents the corrected image light to a user of the VR headset 105. In various embodiments, the optics block 118 includes one or more optical elements. Example optical elements included in the optics block 118 include: an aperture, a Fresnel lens, a convex lens, a concave lens, a filter, or any other suitable optical element that affects image light. Moreover, the optics block 118 may include combinations of different optical elements. In some embodiments, one or more of the optical elements in the optics block 118 may have one or more coatings, such as anti-reflective coatings.

Magnification of the image light by the optics block 118 allows the electronic display 115 to be physically smaller, weigh less, and consume less power than larger displays. Additionally, magnification may increase a field of view of the content presented by the electronic display 115. For example, the field of view of the displayed content is such that the displayed content is presented using almost all (e.g., 110 degrees diagonal), and in some cases all, of the user's field of view. Additionally, in some embodiments, the amount of magnification may be adjusted by adding or removing optical elements.

The optics block 118 may be designed to correct one or more types of optical error. Examples of optical error include: two dimensional optical errors, three dimensional optical errors, or some combination thereof. Two dimensional errors are optical aberrations that occur in two dimensions. Example types of two dimensional errors include: barrel distortion, pincushion distortion, longitudinal chromatic aberration, transverse chromatic aberration, or any other type of two-dimensional optical error. Three dimensional errors are optical errors that occur in three dimensions. Example types of three dimensional errors include spherical aberration, comatic aberration, field curvature, astigmatism, or any other type of three-dimensional optical error. In some embodiments, content provided to the electronic display 115 for display is pre-distorted, and the optics block 118 corrects the distortion when it receives image light from the electronic display 115 generated based on the content.

The optics block 118 includes an eyecup assembly for each eye. Each eyecup assembly includes a lens and is configured to direct image light received from the electronic display 115 to the lens, which directs the light to a corresponding eye of a user wearing the VR headset 105. One or more extension rings may be added or removed from an eyecup assembly to decrease or increase, respectively, the spacing between an outer surface of a lens in the eyecup assembly and a corresponding eye of the user. This allows the user to adjust the spacing between the outer surface of lenses in each eyecup assembly and the user's eyes to allow the user to more comfortably use the VR headset 105. For example, users who wear eyeglasses remove one or more extension rings from each eyecup assembly to increase the spacing between the user's eyes and lenses in each eyecup assembly to allow the users to comfortably wear their eyeglasses while using the VR headset 105.

The locators 120 are objects located in specific positions on the VR headset 105 relative to one another and relative to a specific reference point on the VR headset 105. A locator 120 may be a light emitting diode (LED), a corner cube reflector, a reflective marker, a type of light source that contrasts with an environment in which the VR headset 105 operates, or some combination thereof. In embodiments where the locators 120 are active (i.e., an LED or other type of light emitting device), the locators 120 may emit light in the visible band (−380 nm to 750 nm), in the infrared (IR) band (−750 nm to 1 mm), in the ultraviolet band (10 nm to 380 nm), in some other portion of the electromagnetic spectrum, or in some combination thereof.

In some embodiments, the locators 120 are located beneath an outer surface of the VR headset 105, which is transparent to the wavelengths of light emitted or reflected by the locators 120 or is thin enough to not substantially attenuate the wavelengths of light emitted or reflected by the locators 120. Additionally, in some embodiments, the outer surface or other portions of the VR headset 105 are opaque in the visible band of wavelengths of light. Thus, the locators 120 may emit light in the IR band under an outer surface that is transparent in the IR band but opaque in the visible band.

The IMU 130 is an electronic device that generates fast calibration data indicating an estimated position of the VR headset 105 relative to an initial position of the VR headset 105 based on measurement signals received from one or more of the position sensors 125. A position sensor 125 generates one or more measurement signals in response to motion of the VR headset 105. Examples of position sensors 125 include: one or more accelerometers, one or more gyroscopes, one or more magnetometers, another suitable type of sensor that detects motion, a type of sensor used for error correction of the IMU 130, or some combination thereof. The position sensors 125 may be located external to the IMU 130, internal to the IMU 130, or some combination thereof.

Based on the one or more measurement signals generated by the one or more position sensors 125, the IMU 130 generates fast calibration data indicating an estimated position of the VR headset 105 relative to an initial position of the VR headset 105. For example, the position sensors 125 include multiple accelerometers to measure translational motion (forward/back, up/down, left/right) and multiple gyroscopes to measure rotational motion (e.g., pitch, yaw, roll). In some embodiments, the IMU 130 rapidly samples the measurement signals from various position sensors 125 and calculates the estimated position of the VR headset 105 from the sampled data. For example, the IMU 130 integrates the measurement signals received from one or more accelerometers over time to estimate a velocity vector and integrates the velocity vector over time to determine an estimated position of a reference point on the VR headset 105. Alternatively, the IMU 130 provides the sampled measurement signals to the VR console 110, which determines the fast calibration data. The reference point is a point that may be used to describe the position of the VR headset 105. While the reference point may generally be defined as a point in space; however, in practice the reference point is defined as a point within the VR headset 105 (e.g., a center of the IMU 130).

The IMU 130 receives one or more calibration parameters from the VR console 110. As further discussed below, the one or more calibration parameters are used to maintain tracking of the VR headset 105. Based on a received calibration parameter, the IMU 130 may adjust one or more IMU parameters (e.g., sample rate). In some embodiments, certain calibration parameters cause the IMU 130 to update an initial position of the reference point so it corresponds to a next calibrated position of the reference point. Updating the initial position of the reference point as the next calibrated position of the reference point helps reduce accumulated error associated with the determined estimated position. The accumulated error, also referred to as drift error, causes the estimated position of the reference point to “drift” away from the actual position of the reference point over time.

The imaging device 135 generates slow calibration data in accordance with calibration parameters received from the VR console 110. Slow calibration data includes one or more images showing observed positions of the locators 120 that are detectable by the imaging device 135. The imaging device 135 may include one or more cameras, one or more video cameras, any other device capable of capturing images including one or more of the locators 120, or some combination thereof. Additionally, the imaging device 135 may include one or more filters (e.g., for increasing signal to noise ratio). The imaging device 135 is configured to detect light emitted or reflected from locators 120 in a field of view of the imaging device 135. In embodiments where the locators 120 include passive elements (e.g., a retroreflector), the imaging device 135 may include a light source that illuminates some or all of the locators 120, which retro-reflect the light towards the light source in the imaging device 135. Slow calibration data is communicated from the imaging device 135 to the VR console 110, and the imaging device 135 receives one or more calibration parameters from the VR console 110 to adjust one or more imaging parameters (e.g., focal length, focus, frame rate, ISO, sensor temperature, shutter speed, aperture, etc.).

The VR input interface 140 is a device that allows a user to send action requests to the VR console 110. An action request is a request to perform a particular action. For example, an action request may be to start or to end an application or to perform a particular action within the application. The VR input interface 140 may include one or more input devices. Example input devices include: a keyboard, a mouse, a game controller, a joystick, a yoke, or any other suitable device for receiving action requests and communicating the received action requests to the VR console 110. An action request received by the VR input interface 140 is communicated to the VR console 110, which performs an action corresponding to the action request. In some embodiments, the VR input interface 140 may provide haptic feedback to the user in accordance with instructions received from the VR console 110. For example, haptic feedback is provided when an action request is received, or the VR console 110 communicates instructions to the VR input interface 140 causing the VR input interface 140 to generate haptic feedback when the VR console 110 performs an action.

The VR console 110 provides content to the VR headset 105 for presentation to the user in accordance with information received from one or more of: the imaging device 135, the VR headset 105, and the VR input interface 140. In the example shown in FIG. 1, the VR console 110 includes an application store 145, a tracking module 150, and a virtual reality (VR) engine 155. Some embodiments of the VR console 110 have different components than those described in conjunction with FIG. 1. Similarly, the functions further described below may be distributed among components of the VR console 110 in a different manner than is described here.

The application store 145 stores one or more applications for execution by the VR console 110. An application is a group of instructions, that when executed by a processor, generates content for presentation to the user. Content generated by an application may be in response to inputs received from the user via movement of the VR headset 105 or the VR interface device 140. Examples of applications include: gaming applications, conferencing applications, video playback application, or other suitable applications.

The tracking module 150 calibrates the system environment 100 using one or more calibration parameters and may adjust one or more calibration parameters to reduce error in determination of the position of the VR headset 105. For example, the tracking module 150 adjusts the focus of the imaging device 135 to obtain a more accurate position for observed locators on the VR headset 105. Moreover, calibration performed by the tracking module 150 also accounts for information received from the IMU 130. Additionally, if tracking of the VR headset 105 is lost (e.g., the imaging device 135 loses line of sight of at least a threshold number of the locators 120), the tracking module 140 re-calibrates some or all of the system environment 100.

The tracking module 150 tracks movements of the VR headset 105 using slow calibration information from the imaging device 135. For example, the tracking module 150 determines positions of a reference point of the VR headset 105 using observed locators 120 from the slow calibration information and a model of the VR headset 105. The tracking module 150 also determines positions of a reference point of the VR headset 105 using position information from the fast calibration information. Additionally, in some embodiments, the tracking module 150 may use portions of the fast calibration information, the slow calibration information, or some combination thereof, to predict a future location of the headset 105. The tracking module 150 provides the estimated or predicted future position of the VR headset 105 to the VR engine 155.

The VR engine 155 executes applications within the system environment 100 and receives position information, acceleration information, velocity information, predicted future positions, or some combination thereof, of the VR headset 105 from the tracking module 150. Based on the received information, the VR engine 155 determines content to provide to the VR headset 105 for presentation to the user. For example, if the received information indicates that the user has looked to the left, the VR engine 155 generates content for the VR headset 105 that mirrors the user's movement in a virtual environment. Additionally, the VR engine 155 performs an action within an application executing on the VR console 110 in response to an action request received from the VR input interface 140 and provides feedback to the user that the action was performed. The provided feedback may be visual or audible feedback via the VR headset 105 or haptic feedback via the VR input interface 140.

FIG. 2A is a wire diagram of a virtual reality (VR) headset 200, in accordance with an embodiment. The VR headset 200 is an embodiment of the VR headset 105, and includes a front rigid body 205 and a band 210. The front rigid body 205 includes one or more electronic display elements of the electronic display 115 (not shown), the IMU 130, the one or more position sensors 125, and the locators 120. In the embodiment shown by FIG. 2A, the position sensors 125 are located within the IMU 130, and neither the IMU 130 nor the position sensors 125 are visible to the user.

The locators 120 are located in fixed positions on the front rigid body 205 relative to one another and relative to a reference point 215. In the example of FIG. 2A, the reference point 215 is located at the center of the IMU 130. Each of the locators 120 emit light that is detectable by the imaging device 135. Locators 120, or portions of locators 120, are located on a front side 220A, a top side 220B, a bottom side 220C, a right side 220D, and a left side 220E of the front rigid body 205 in the example of FIG. 2A.

FIG. 2B is a cross section 225 of the front rigid body 205 of the embodiment of the VR headset 200 shown in FIG. 2A. As shown in FIG. 2B, the front rigid body 205 includes an optical block 230 that provides altered image light to an exit pupil 250. The exit pupil 250 is a location where a user's eye 245 is positioned while using the VR headset 200. For purposes of illustration, FIG. 2B shows a cross section 225 associated with a single eye 245, but another optical block, separate from the optical block 230, provides altered image light to another eye of the user.

The optical block 230 includes an electronic display element 235 of the electronic display 115, and the optics block 118. The electronic display element 235 emits image light toward the optics block 118. In some embodiments, the optics block 118 corrects for one or more optical errors (e.g., distortion, astigmatism, etc.) via one or more optical elements or other components. The optics block 118 directs, via an eyecup assembly, corrected image light to the exit pupil 250 for presentation to the user. In some embodiments, optical elements for correcting one or more optical errors included in the eyecup assembly.

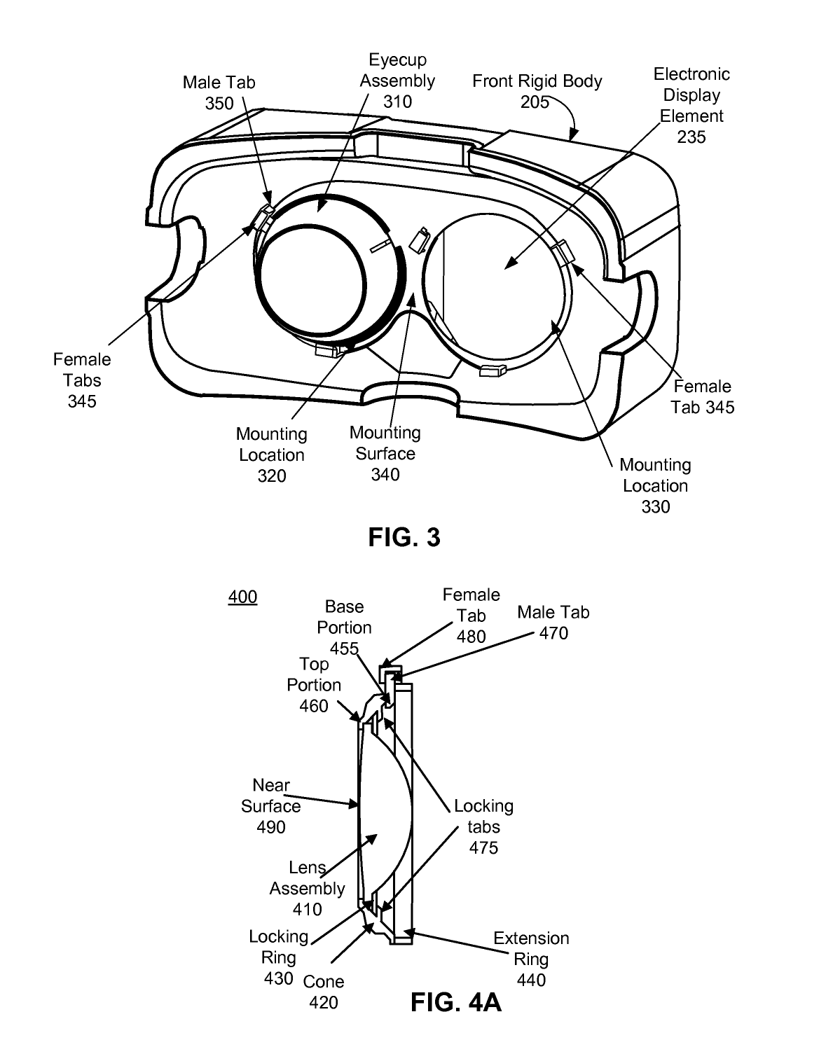

FIG. 3 is a wire diagram of an embodiment of the front rigid body 205 of the VR headset 200 shown in FIG. 2A with an eyecup assembly 310 for the left eye mounted. The front rigid body 205 includes a left mounting location 320 and a right mounting location 330 that are both components of a mounting surface 340. The left mounting location 320 and the right mounting location 330 each include one or more female tabs 340. The eyecup assembly 310 includes a plurality of male tabs 350 that join with corresponding female tabs 340 on the left mounting location 320. In FIG. 3, the right mounting location 330 is left open to show the electronic display element 235. In alternate embodiments, the eyecup assembly 310 may couple to the left mounting location 320 and/or the right mounting location 330 using some other mechanism (e.g., pressure fitted into place, snapped into place, etc.).

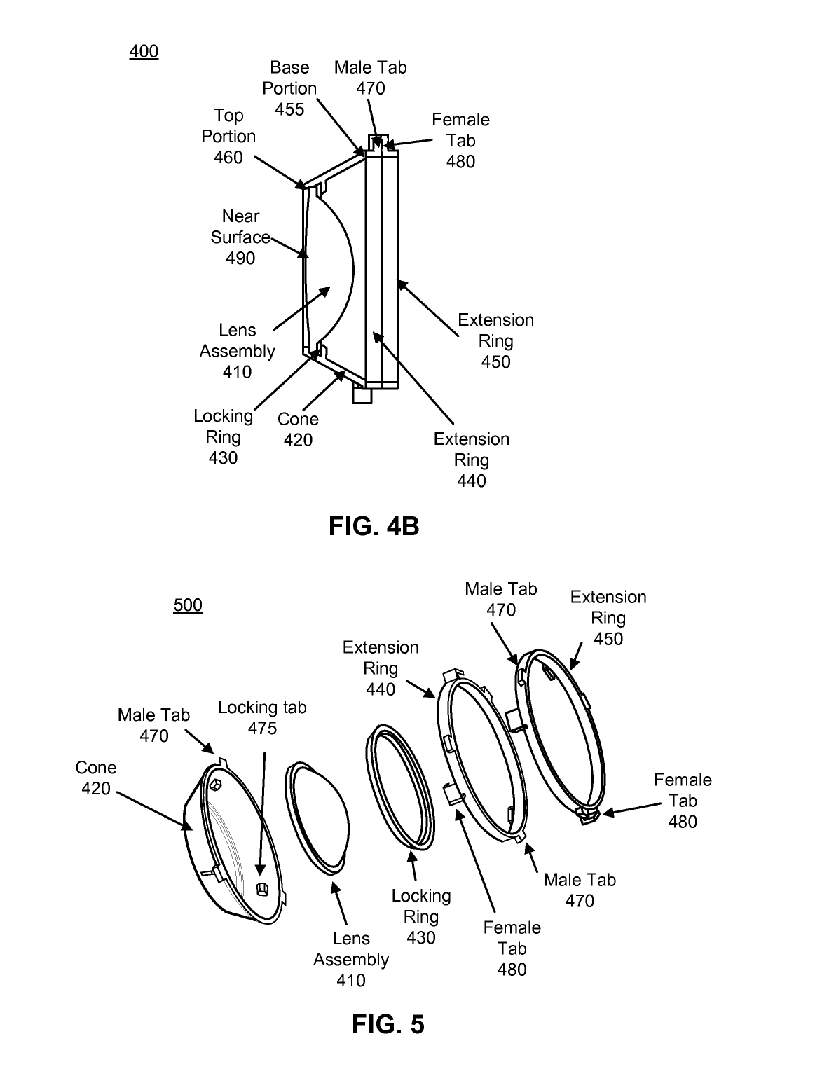

FIG. 4A is a cross section of an embodiment of an eyecup assembly 400 configured for use by a user with eyeglasses. The eyecup assembly 400 includes a cone 410, a lens assembly 420, a locking ring 430, and an extension ring 440. However, in other embodiments, the eyecup assembly 400 may include different and/or additional components.

The cone 410 includes a base portion 455 and a top portion 460, with the top portion coupled to the lens assembly 420 and configured to hold the lens assembly 420. Image light is received by the cone 410 via the base portion 455, which directs the image light toward the lens assembly 420. In various embodiments, the cone 410 is composed of a material that is opaque to visible light or that is opaque to any suitable wavelengths of light. Additionally, the cone 410 has a shape (e.g., a conical shape) so a field of view of the electronic display 235 element from the exit pupil corresponding to the lens assembly 420 is not obstructed by the extension ring 440.

In some embodiments, the base portion 455 includes one or more male tabs 470 for coupling to the extension ring 440 or to a mounting surface 340 of the front rigid body 205 of a VR headset 200. Additionally, the cone 410 includes one or more locking tabs 475 used in combination with the locking ring 430 to secure the lens assembly 420 to the top portion 460 of the cone 410. However, in other embodiments, the lens assembly 420 may be secured to the top portion 460 of the cone 410 using any suitable method.

The lens assembly 420 includes one or more optical elements and is configured to direct portions of the image light to a corresponding exit pupil 250. As described above, the exit pupil 250 corresponds to a location of an eye of a user of the VR headset 200. Additionally, in some embodiments, the lens assembly 420 is configured to correct one or more types of optical error and/or magnify the image light.

The locking ring 430 is configured to secure the lens assembly 420 to the top portion 460 of the cone 410. In various embodiments, the locking ring 430 is configured to secure an outer edge of the lens assembly 420 to the top portion 460 of the cone 410. In some embodiments, the lens assembly 420 is secured to the top portion 460 of the cone in place via the locking ring 430, which is held in place by one or more locking tabs 475. In alternative embodiments, the locking ring 430 may be held in place via some other method (e.g., via epoxy).

The extension ring 440 is configured to attach to the mounting surface 340 of the front rigid body 205 of the VR headset 200 and to the base portion 455 of the cone 410, so a distance between the mounting surface 340 and the base portion 455 is at least a thickness of the extension ring 440. In some embodiments, the extension ring 440 includes one or more male tabs 470 (visible in FIGS. 4B and 5), and one or more female tabs 480. The one or more male tabs 470 are configured to couple to corresponding female tabs 480 on an additional extension ring 440 or on the mounting surface 340. Similarly, the one or more female tabs 480 are configured to couple to corresponding male tabs 470 on the additional extension ring 440 or on the base portion 455 of the cone 410. In some embodiments, the thickness of the extension ring 440 is selected so that when the extension ring 440 is coupled the mounting surface 340, a distance between the exit pupil 250 and an outer surface 490 of the lens assembly 420 is sufficient for a user to wear glasses (e.g., the extension ring 440 has a thickness matching an average thickness of eyeglasses or matching a minimum thickness of eyeglasses). For example a thickness of the extension ring results in a distance of 15 mm between the exit pupil 250 and the outer surface 490 of the lens assembly 420.

If a user would like to further increase the distance between the outer surface 490 of the lens assembly and the exit pupil 250, the extension ring 440 may be removed from the eyecup assembly 400, so the cone 410 directly couples to the mounting surface 340 of the VR headset 200. As noted above, the base portion 455 of the cone 410 includes one or more male tabs 470 are configured to couple to corresponding female tabs 480 on the mounting surface 340 of the VR headset 200.

FIG. 4B is a cross section of one embodiment of the eyecup assembly 400 of FIG. 4A configured for use by a user without eyeglasses. In the embodiment shown by FIG. 4B, the eyecup assembly 400 includes an additional extension ring 450 that reduces the spacing distance between the exit pupil 250 and the outer surface 490 of the lens assembly 420 by a thickness of the additional extension ring 450. Configurations using both the extension ring 440 and the additional extension ring 450 are useful for users who do not wear eyeglasses as the combination of the extension ring 440 and the additional extension ring 450 moves the outer surface 490 of the lens assembly 420 closer to the user's eye.

The additional extension ring 450 includes one or more male tabs 470 and one or more female tabs 480. The one or more female tabs 480 couple to the one or more male tabs 470 on the extension ring 440. Additionally, the one or more male tabs 470 of the additional extension ring 450 are configured to couple to a female tab on another extension ring or to the base portion 455 of the cone 410.

FIG. 5 is a wire diagram of an exploded view 500 of the eyecup assembly 400 shown in FIG. 4B. As described above in conjunction with FIG. 4A, the locking ring 430 is configured to secure the lens assembly 420 to the top portion 460 of the cone 410. The extension ring 440 is configured to attach to the mounting surface 340 of the front rigid body 205 of the VR headset 200 and to the base portion 455 of the cone 410, with the locking ring 430 and the lens assembly 420 between the extension ring 440 and the top portion 460 of the cone 410.

### SUMMARY

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosed embodiments are intended to be illustrative, but not limiting, of the scope of the disclosure, which is set forth in the following claims.

What is claimed is:

1. A virtual reality (VR) headset comprising:
an electronic display element configured to output image light;
an optics block configured to receive the image light, the optics block comprising:
a lens and an additional lens each configured to direct portions of the image light to corresponding exit pupils that correspond to locations of eyes of a user of the VR headset;
a cone including a base portion and a top portion, the top portion coupled to the lens, the cone configured to receive the image light through the base portion and to direct the image light toward the lens;
an additional cone including an additional base portion and an additional top portion, the additional top portion coupled to the additional lens, the additional cone configured to receive image light through the additional base portion and to direct the image light toward the additional lens;
an extension ring configured to couple to a mounting surface of a rigid body of the VR headset and to the base portion of the cone so a distance between the mounting surface and the base portion is at least a thickness of the extension ring; and
an additional extension ring configured to couple to the mounting surface and to the additional base potion of the additional cone so a distance between the mounting surface and the additional base portion is at least a thickness of the additional extension ring.

2. The virtual reality headset of claim 1, wherein the extension ring includes one or more female tabs, and the base portion of the cone includes one or more male tabs configured to couple to the one or more female tabs on the extension ring.

3. The virtual reality headset of claim 1, wherein the additional extension ring includes one or more male tabs configured to couple to the one or more female tabs on the mounting surface of the rigid body.

4. The virtual reality headset of claim 1, wherein a distance between the exit pupil corresponding to the lens and an outer surface of the lens is 10 mm.

5. The virtual reality headset of claim 1, further comprising:
another extension ring configured to attach to the mounting surface of the rigid body of the VR headset and to attach to the extension ring.

6. The virtual reality headset of claim 5, wherein a spacing distance between the exit pupil corresponding to the lens and an outer surface of the lens is 15 mm.

7. The virtual reality headset of claim 5, wherein the thickness of the extension ring, the thickness of the additional extension ring, and a thickness of the other extension ring are equal.

8. The virtual reality headset of claim 5, wherein the extension ring includes one or more male tabs and the other extension ring includes one or more female tabs that join to the one or more male tabs.

9. The virtual reality headset of claim 1, wherein the thickness of the extension ring and the thickness of the additional extension ring are equal.

10. The virtual reality headset of claim 1, wherein the cone has a conical shape configured to prevent obstruction of a field of view the electronic display to the exit pupil corresponding to the lens by the extension ring.

11. A virtual reality (VR) headset comprising:
an electronic display element configured to output image light;
an optics block configured to receive the image light, the optics block comprising:
a lens configured to direct portions of the image light to a corresponding exit pupil that corresponds to a location of an eye of a user of the VR headset;
a cone including a base portion and a top portion, the top portion coupled to the lens, the cone configured to receive the image light through the base portion and direct the image light toward the lens; and
an extension ring configured to couple to a mounting surface of a rigid body of the VR headset and to the base portion of the cone so a distance between the mounting surface and the base portion is at least a thickness of the extension ring.

12. The virtual reality headset of claim 11, wherein a distance between the exit pupil corresponding to the lens and an outer surface of the lens is 15 mm.

13. The virtual reality headset of claim 11, wherein the extension ring includes one or more female tabs and the base portion of the cone includes one or more male tabs configured to couple to the one or more female tabs on the extension ring.

14. The virtual reality headset of claim 11, further comprising:
an additional lens configured to direct portions of the image light to a corresponding exit pupil that corresponds to a location of another eye of the user;
an additional cone including an additional base portion and an additional top portion, the additional top portion coupled to the additional lens, the additional cone configured to receive image light through the additional base portion and to direct the image light toward the additional lens; and
an additional extension ring configured to couple to the mounting surface and to the additional base potion of the additional cone so a distance between the mounting surface and the additional base portion is at least a thickness of the additional extension ring.

15. The virtual reality headset of claim 14, wherein the additional extension ring includes one or more male tabs configured to couple to the one or more female tabs on the mounting surface of the rigid body.

16. The virtual reality headset of claim 11, further comprising:
an additional extension ring configured to attach to the mounting surface of the rigid body of the VR headset and to attach to the extension ring.

17. The virtual reality headset of claim 16, wherein the thickness of the extension ring and a thickness of the additional extension ring are equal.

18. The virtual reality headset of claim 16, wherein a spacing distance between the exit pupil corresponding to the lens and an outer surface of the lens is 10 mm.

19. The virtual reality headset of claim 16, wherein the extension ring includes one or more male tabs, and the additional extension ring includes one or more female tabs configured to couple to the one or more male tabs.

20. The virtual reality headset of claim 11, wherein the cone has a conical shape configured to prevent obstruction of a field of view the electronic display to the exit pupil corresponding to the lens by the extension ring.
